(19) United States
(12) Patent Application Publication
(10) Pub. No.: US 2026/0227258 A1
(43) Pub. Date: Aug. 6, 2026

(54) METHOD FOR PRODUCING A PRESSURE SENSOR

(71) Applicant: Endress+Hauser SE+Co. KG, Maulburg (DE)

(72) Inventors: Andreas Roßberg, Bad Säckingen (DE); Elke Schmidt, Bad Säckingen (DE); Martin Burgard, Schopfheim (DE)

(21) Appl. No.: 19/137,067

(22) PCT Filed: Nov. 7, 2023
(86) PCT No.: PCT/EP2023/080952

§ 371 Date: Jun. 9, 2025

(30) Foreign Application Priority Data
Dec. 13, 2022 (DE) 10 2022 133 114.8

(51) Int. Cl. G01L 9/00

(52) U.S. Cl. CPC G01L 9/0072

(57) ABSTRACT

A method for producing a pressure sensor includes steps of providing a ceramic platform, providing a measuring diaphragm, providing an electromechanical transducer, and providing at least one titanium core for an electrically conductive, contact pin. The method also includes producing a layer on a surface of the titanium core passivating against the alloying of titanium from the titanium core in a melt of an active braze. The contact pin is inserted in a seat intended for the contact pin and extending through the platform. The contact pin is electrically connected with a component of the electromechanical transducer on a diaphragm-facing side of the platform and is joined with the platform using the active braze on at least a diaphragm-far side of the platform, such that the titanium of the titanium core does not alloy with the melt of the active braze.

The invention relates to a method for producing a pressure sensor as well as to a pressure sensor.

Pressure sensors are applied in industrial measurements technology for metrological registering of pressures.

For this, among others, also ceramic pressure sensors are applied, which comprise at least one ceramic body, such as e.g. a platform, and/or a measuring diaphragm connected with the platform and enclosing a pressure chamber. In the case of these pressure sensors, it is, depending on embodiment, necessary to connect one or more ceramic body of the pressure sensor, in each case, by means of at least one joint of metal. These joints must, depending on position of the same, in given cases, fulfill high requirements of pressure resistance and/or seal.

An example for this are leads each comprising a metal body of pin shape connected by means of a joint pressure-tightly with the platform and extending through the platform, in order to make a sensor component of the pressure sensor connected thereto electrically contactable through the platform and/or connectable to a measuring electronics.

Thus, for example, described in DE 10 2008 043 567 A1 is a pressure sensor, which comprises a ceramic platform as well as a ceramic measuring diaphragm connected with the platform, enclosing a pressure chamber, and loadable with a pressure to be registered metrologically by the pressure sensor. This pressure sensor is equipped with a capacitive, electromechanical transducer, which is embodied in such a manner that it converts a deflection of the measuring diaphragm dependent on the pressure acting on the measuring diaphragm into an electrical variable. Additionally, the pressure sensor includes a lead, which extends through the platform and via which an electrode of a capacitor of the capacitive transducer is electrically connectable. The lead comprises a metal body connected to the electrode, formed as a tantalum pin, and set in a bore extending through the platform and communicating with pressure chamber. The tantalum pin is connected terminally with the ceramic platform by means of an active hard solder or braze, which terminally seals a gap between the platform and the therein installed, tantalum pin.

As a result, the pressure resistance and the seal of the active hard soldering or braze are highly co-determining for the pressure resistance and the seal of the lead. Since the bore communicates with the pressure chamber, a high pressure resistance of the active hard solder or braze is especially necessary, when the pressure chamber can in measurement operation, in given cases, be exposed to very high pressures. This is especially the case for pressure difference sensors, which have a measuring diaphragm arranged between two platforms, connected with each of the platforms and enclosing, in each case, pressure chambers with each of the platforms. A tight seal is e.g. especially necessary, when the pressure sensor is formed as an absolute pressure sensor, whose pressure chamber is evacuated, however, also in the case of relative- and pressure difference sensors.

Active brazings are produced by means of an active hard solder, or braze, which includes an active component, which reacts with the ceramic during the brazing. In such case, reduction of the ceramic effects a mechanically very strong chemical connection between the ceramic and the active hard solder, or braze.

Active hard solders, or brazes, offer the advantage that, due to the therein contained, active component, they are able to wet ceramic components and enable a direct soldering of ceramic components, without preceding metallizing of the ceramic.

Disadvantageous in such approach, however, is that tantalum pins exert an, indeed, only very small, however, nevertheless measurable, disadvantageous influence on achievable accuracy of measurement, which shows up especially in the form of a temperature dependent, measurement error.

Insofar, is DE 10 2018 108743 A1 describes the advantages of the application of titanium as material for the leads, or pins. Disadvantageous in the application of titanium rods as laid is, however, that an active hard solder, or braze, especially an Ag—Cu—Ti-active hard solder, or braze, brings about very vigorous reactions with the titanium of the pin during the soldering process. This, in turn, leads to the fact that, on the one hand, a lack of sealing can occur and, on the other hand, that an assured electrical contacting cannot be made.

An object of the invention is, thus, to provide a remedy for such situation.

The object is achieved according to the invention by the method as defined in claim 1 and the pressure sensor as defined in claim 7.

The method of the invention for producing a pressure sensor comprises steps as follows:
providing a ceramic platform,
providing a measuring diaphragm connected with the platform, enclosing a pressure chamber, and contactable with a pressure to be registered metrologically by the pressure sensor,
providing an electromechanical transducer, which is embodied in such a manner that it converts a deflection of the measuring diaphragm dependent on the pressure acting on the measuring diaphragm into an electrical variable,
providing at least one titanium core for an electrically conductive, contact pin to serve for electrical contacting of a component of the electromechanical transducer through the platform;
producing a layer on a preferably all sides surrounding surface of the titanium core passivating against the alloying of titanium from the titanium core in a melt of an active braze;
inserting the contact pin in a seat, especially a bore, intended for the contact pin and extending through the platform;
electrical connecting of the contact pin with the component of the electromechanical transducer on a diaphragm-facing side of the platform; and
joining the contact pin with the platform by means of the active braze on at least a diaphragm-far side of the platform, such that the titanium of the titanium core does not alloy with the melt of the active braze.

According to the invention, the production, or application, of a passivation layer on a titanium core to serve in a ceramic platform of a pressure sensor as contact pin for a lead is proposed in order so to be able to join the passivated contact pin using an active hard solder, or braze, without that the titanium of the titanium core chemically reacts with a component of the active braze.

An advantageous form of embodiment of the method of the invention can provide that the layer passivated against the alloying of titanium from the titanium core into the melt is produced by an oxidation or a nitriding with a nitrogen at a defined temperature, preferably at a temperature less than 450° C., especially preferably at a temperature in a range from 300° C. to 400° C.

An alternative form of embodiment can provide that the layer is formed by coating the surface of the titanium core with a material passivating against the alloying of the titanium into the melt and/or that the layer is formed by coating the surface of the titanium core with tantalum, molybdenum, nickel, a nickel-alloy or another metal or a metal oxide, e.g. titanium oxide, passivating against the alloying of the titanium with the melt. Furthermore, the form of embodiment can provide that the coating of the surface of the titanium core is performed by a sputtering process, especially a sputtering process for sputtering of piled pieces.

In turn, another form of embodiment of the method of the invention can provide that the joining of the contact pin with the platform is performed by means of an Ag—Cu-active hard solder, or braze (silver-copper-active braze), preferably with titanium as active component.

The invention relates further to a pressure sensor, especially one resulting from one or more of the above described forms of embodiment, comprising:
a ceramic platform,
a measuring diaphragm connected with the platform, enclosing a pressure chamber, and contactable with a pressure to be registered metrologically by the pressure sensor,
an electromechanical transducer, which is embodied in such a manner that it converts a deflection of the measuring diaphragm dependent on the pressure acting on the measuring diaphragm into an electrical variable, and
at least one electrically conductive, contact pin, which is connected to a component of the pressure sensor, which extends through the platform, and via which the component connected thereto is electrically connectable,
wherein the at least one contact pin comprises a titanium core and a layer surrounding a surface of the titanium core, preferably on all sides, and preventing an alloying of the titanium of the titanium core in a melt of an active braze, wherein the at least one contact pin is inserted in a seat intended for it, especially a bore of the platform, and is electrically connected to its component of the transducer on a diaphragm-facing side of the platform, and wherein the at least one contact pin is joined with the platform on at least a diaphragm-far side of the platform via the active hard solder, or braze, wherein the titanium of the titanium core does not alloy with the melt of the active braze.

The invention will now be explained in greater detail based on the appended drawing, the figures of which show as follows:

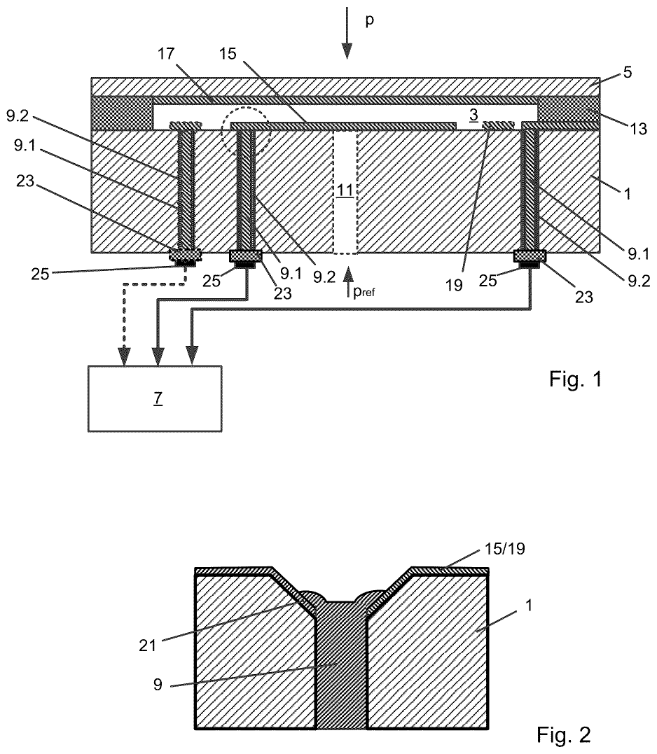

FIG. 1 an example of a pressure sensor of the invention, and

FIG. 2 circled in FIG. 1, a diaphragm-facing region of the contact pin installed in the platform.

FIG. 1 shows an example of a pressure sensor of the invention, comprising a ceramic platform 1 and a measuring diaphragm 5 connected with the platform 1, enclosing a pressure chamber 3, and loadable by a pressure p to be registered metrologically by the pressure sensor.

Individual parts of pressure sensors of the invention can have different embodiments usable individually or in combination with one another. Examples of such will now be described based on the figures.

The pressure sensor shown in FIG. 1 is formed, by way of example, as an absolute pressure sensor, which metrologically registers a pressure p acting on an outside of the measuring diaphragm 5. In such case, the pressure chamber 3 enclosed beneath the measuring diaphragm 5 is evacuated. Alternatively, the pressure sensor can be formed as a relative pressure sensor, which registers a pressure p acting on the outside of the measuring diaphragm 5 with respect to a reference pressure Pref supplied to the pressure chamber 3 via a pressure supply line 11 extending through the platform 1 and drawn dashed in FIG. 1 as an option. The invention, is, however, analogously also usable in connection with ceramic, pressure difference sensors.

Independently of whether the pressure sensor is formed as an absolute-, relative- or pressure difference sensor, such platform 1 and its measuring diaphragm 5 have, in each case, dimensions predetermined as a function of a pressure measuring range of the pressure sensor. Thus, the platform 1 can have, depending on pressure measuring range, e.g. a diameter in the order of magnitude of greater than or equal to 1.5 cm, especially 1.5 cm to 3.5 cm, and a thickness in the order of magnitude of greater than or equal to a plurality of millimeters, especially of 0.4 cm to 0.5 cm. In such case, the measuring diaphragm 5 has, depending on pressure measuring range, e.g. a diaphragm thickness of greater than or equal to one or more tenths of millimeters. For measuring very high pressures, in the case of corresponding increasing of the thickness of the platform 1, also diaphragm thicknesses of up to a plurality of millimeters can be applied.

Independently of the embodiment of the pressure sensor in this regard, platform 1 and measuring diaphragm 5 can be connected together, for example, by means of a joint 13 connecting an outer edge of the measuring diaphragm 5 with an outer edge of the platform 1 and surrounding the pressure chamber 3 externally on all sides. Suited as joint 13 is e.g. an active hard solder or braze, such as e.g. an active hard solder or braze produced by means of an active hard solder, or braze, comprising zirconium, nickel and titanium.

Additionally, the pressure sensor includes an electromechanical transducer, which is embodied in such a manner that it converts a deflection of the measuring diaphragm 5 dependent on the 5 pressure acting on the measuring diaphragm into an electrical variable. This electrical variable can be registered, for example, by means of a measuring electronics 7 connected or to be connected to the transducer and converted into a signal reflecting the pressure to be measured and displayed as a measurement signal output and/or made available for additional processing and/or evaluation.

The electromechanical transducer can be formed, for example, as a capacitive transducer, which comprises a measuring capacitor with a measured capacitance Cp dependent on the pressure dependent deflection of the measuring diaphragm 5. The measuring capacitor shown in such case includes, as an example, a measuring electrode 15 applied on a diaphragm-facing, front face of the platform 1 and a counter electrode 17 arranged on an inside of the measuring diaphragm 5 facing the platform 1. In the case of the example shown in FIG. 1, the measuring electrode 15 forms one of the components of the transducer, is electrically connected, or connectable, via a contact pin 9 connected thereto, is formed according to the invention, and will be described in yet greater detail below.

Optionally, the transducer can comprise at least one additional capacitor. An example for such is a reference capacitor likewise shown in FIG. 1 as an option. This includes in the illustrated example a reference electrode 19 applied on the diaphragm-facing, front face of the platform 5 and shown dashed in FIG. 1 as an option, which forms together with the counter electrode 17 the reference capacitor C_{R}. Furthermore, also the reference electrode 19 can represent one of the components of the transducer, which is connectable, or connected, with a contact pin formed according to the invention and will be described below in yet greater detail.

The electrical connection of the counter electrode 17 occurs preferably via the thereon bordering, electrically conductive joint 13, which can be directly outwardly contacted. Alternatively, the electrical connection of the counter electrode 17 can, however, also occur, such as shown in FIG. 1, via an additional contact pin formed according to the invention. The contact pin extends, in such case, through the platform 1 directly to the joint 13 or alternatively to a connection region connected to the joint 13 and implemented, for example, by a metallizing.

The reference capacitor is preferably formed in such a manner that its reference capacity C_{R} has no or only a small dependence on the pressure dependent deflection of the measuring diaphragm 5. This is achieved in the illustrated example by making the reference electrode 19 a disk shaped or washer segment shaped electrode, which outwardly surrounds the, in such case, circular disc shaped measuring electrode 15.

Measuring electrode 15 and counter electrode 17, as well as also the, in given cases, provided, reference electrode 19, are, in each case, made of an electrically conductive electrode material. Suited for this, are, for example, materials comprising tantalum, tantalum oxide, titanium and/or titanium oxide

In pressure sensors using a capacitive transducer, the pressure to be measured is ascertained by means of the measuring electronics 7 to be connected, or connected, to the transducer preferably based on an auxiliary variable C_{V} dependent on the measured capacitance C_{P}. That can be e.g. an auxiliary variable C_{V} dependent exclusively on the measured capacitance C_{P} or alternatively dependent on the measured capacitance C_{P} and the reference capacity C_{R}. Suited as auxiliary variable C_{V} is e.g. an auxiliary variable C_{V} dependent on a difference between measured capacitance C_{P} and reference capacity C_{R} and related to the measured capacitance C_{P}, such as e.g.

$${C}_{V} = ( {C}_{P} - {C}_{R} ) / {C}_{P} .$$

The invention, is, however, not limited to pressure sensors with capacitive transducers, but, instead, can be analogously applied also in connection with pressure sensors, which are equipped with an electromechanical transducer based on another transducer principle, and comprise at least one component, which is contactable via a contact pin extending through the platform and connected thereto.

If the pressure sensor, such as shown in FIG. 1, comprises two or more components contactable, in each case, via one of the contact pins 9, then the following explanations hold correspondingly as regards the contact pin formed according to the invention for at least one or a part of the contact pins and even all contact pins 9.

The contact pin embodied according to the invention includes a titanium core with a layer surrounding the titanium core, preferably on all sides. The titanium core can preferably be of titanium Grade 1, titanium Grade 2, titanium Grade 4 or titanium Grade 5. These materials have not only in their specified temperature range, but, beyond that, in a very large temperature range, a modulus of elasticity in the range from 105 kN/mm² to 115 kN/mm² and a very well ceramic matched coefficient of thermal expansion in the range from 8*10⁻⁶/K to 9*10⁻⁶/K. In comparison thereto, tantalum pins applied in the above mentioned state of the art have a significantly larger modulus of elasticity of greater than 180 kN/mm² and a coefficient of thermal expansion in the range from 6*10⁻⁶/K to 7*10⁻⁶/K. The contact pins 9 can have, for example, a diameter in the range from 0.5 mm to 0.8 mm.

The production of the titanium cores occurs preferably by producing from a blank by a drawing process an essentially full cylinder rod, which has a diameter corresponding to the diameter of the desired contact pins 9. From this rod, then titanium rods of the desired length are cut.

In order to prevent an alloying the titanium of the titanium core in an, especially, Ag—Cu-melt (silver-copper-melt) during the brazing process, according to the invention, is produced on a surface of the titanium core a layer, which has a passivation effect blocking the alloying of the titanium. In such case, such a passivation coating acting to block the alloying of the titanium into the, especially Ag—Cu melt can be made on the surface of the titanium core, for example, by an oxidation or nitriding with a nitrogen at a defined temperature, especially at a temperature less than 450° C., quite especially at a temperature in the range from 300° C. to 400° C.

Alternatively, the coating can also occur using a material passivating against the alloying of the titanium into the, especially, Ag—Cu melt. Proven as especially advantageous materials, which have a passivation effect against the alloying of the titanium into the Ag—Cu-melt, are tantalum (Ta), molybdenum (Mo), nickel, a nickel-alloy or other passivation metals or metal oxides, such as e.g. titanium oxide. These materials can be applied, for example, via a sputtering process, wherein especially the sputtered coating of the titanium cores lumped together is especially advantageous. In such methods, are the titanium cores piled together are placed in a rotating drum, in which a stationary plasma coating source is arranged, such that a good mixing of the titanium cores is provided by the rotational movement during the actual coating.

The contact pin embodied according to the invention is inserted into a seat provided for it in the platform and connected to its component of the transducer. The seat can be, for example, a bore in the platform. For this, methods known in the state of the art can be applied, such as e.g. the method described in DE 10 2008 043 567 A1, in the case of which the contact pin 9 pressed into its bore.

In the pressing, the contact pin 9 is inserted into its bore and pressed against a stop arranged, for example, at the diaphragm-far side of the platform 1. In such case, preferably at the same time, also the electrical connection of the contact pin 9 to its component is effected. For this, the measuring diaphragm 5 facing end of the bore has, in each case, a lateral surface, over which a connection region 21 of its component extends. These lateral surfaces are, in each case, oriented in such a manner that the stop opposite end of the contact pin 9 in the pressing is pressed against the connection region 21 of the particular component arranged on the lateral surface. In this way, in each case, a cold weld is produced, which effects a reliable electrical contact between each contact pin 9 and its connection region 21. In such case, the cold weld produces a reliable electrical contact, even when the contact pin 9 and the connection region 21 are made of mutually differing, electrically conductive materials. In such case, a connection region 21 can be formed e.g. as a part of the particular component or as a contact connected to the particular component.

FIG. 2 shows for this an enlarged view of an embodiment of the circled area in FIG. 1. FIG. 1 only schematically illustrates the diaphragm-facing region of platform 1 with the contact pin 9 pressed therein. FIG. 2 shows that the connection region 21, via which the measuring electrode 15 is connected to the contact pin 9, is formed by a subregion of the measuring electrode 15 arranged on the e.g. funnel shaped, lateral surface of the measuring diaphragm 5 facing end of the bore. Analogously, naturally also the, in given cases, provided reference electrode 19 can comprise a connection region 21 connected to its contact pin 9 and formed by a subregion of the reference electrode 19 arranged on the lateral surface of the measuring diaphragm 5 facing end of its bore.

Furthermore, each contact pin is bonded on a diaphragm-far side of the platform 1 by means of an active hard solder or braze joint and, thus, sealed, especially hermetically sealed. Proved as especially advantageous for the active hard solder or braze is especially an Ag—Cu active hard solder, or braze, 23 having an active component, such as e.g. titanium, zirconium or hafnium, which enables a reactive wetting at the interface solder-platform. In given cases, also a cylindrically shaped gap between each contact pin and its bore can be sealed with the active hard solder, or braze. The electrically conductive, contact pin can be electrically contacted by means of a soft solder 25 appliable, or applied, on the active hard solder or braze 23.

### LIST OF REFERENCE CHARACTERS

1 platform
3 pressure chamber
5 measuring diaphragm
7 measuring electronics
9.1 titanium core of the contact pin
9.2 passivating layer
11 reference pressure supply line
13 joint
15 measuring electrode
17 counter electrode
19 reference electrode
21 connection region
23 active hard solder, or braze, especially an Ag—Cu active hard solder, or braze
25 soft solder

1-7. (canceled)

8. A method for producing a pressure sensor, comprising steps as follows:
providing a ceramic platform;
providing a measuring diaphragm connected with the platform, enclosing a pressure chamber, and contactable with a pressure to be registered metrologically by the pressure sensor;
providing an electromechanical transducer, which is embodied in such a manner that it converts a deflection of the measuring diaphragm dependent on the pressure acting on the measuring diaphragm into an electrical variable;
providing at least one titanium core for an electrically conductive, contact pin to serve for electrical contacting of a component of the electromechanical transducer through the platform;
producing a layer on a preferably all sides surrounding surface of the titanium core passivating against the alloying of titanium from the titanium core in a melt of an active braze;
inserting the contact pin in a seat, especially a bore, intended for the contact pin and extending through the platform;
electrical connecting of the contact pin with the component of the electromechanical transducer on a diaphragm-facing side of the platform; and
joining the contact pin with the platform by means of the active braze on at least a diaphragm-far side of the platform, such that the titanium of the titanium core does not alloy with the melt of the active braze.

9. The method of claim 8, wherein the layer passivated against the alloying of titanium from the titanium core into the melt is produced by an oxidation or a nitriding with a nitrogen at a defined temperature of less than 450° C.

10. The method of claim 8, wherein the layer is formed by coating the surface of the titanium core with a material passivating against the alloying of the titanium into the melt.

11. The method of claim 8, wherein the layer is formed by coating the surface of the titanium core with tantalum, molybdenum, nickel, a nickel-alloy or another metal or a metal oxide, e.g. titanium oxide, passivating against the alloying the titanium into the melt.

12. The method of claim 8, wherein the coating of the surface of the titanium core is performed by a sputtering process, especially a sputtering process for sputtering of piled pieces.

13. The method of claim 8, wherein the joining of the contact pin with the platform is performed using an Ag—Cu-active hard solder, or braze, preferably with titanium as active component.

14. A pressure sensor, comprising:
a ceramic platform;
a measuring diaphragm connected with the platform, enclosing a pressure chamber, and contactable with a pressure to be registered metrologically by the pressure sensor;
an electromechanical transducer, which is embodied in such a manner that it converts a deflection of the measuring diaphragm dependent on the pressure acting on the measuring diaphragm into an electrical variable; and
at least one electrically conductive, contact pin, which is connected to a component of the pressure sensor, which extends through the platform, and via which the component connected thereto is electrically connectable;
wherein the at least one contact pin comprises a titanium core and a layer surrounding a surface of the titanium core, and preventing an alloying the titanium of the titanium core in a melt of an active braze, wherein the at least one contact pin is inserted in an intended seat, especially a bore of the platform, and is electrically connected to its component of the transducer on a diaphragm-facing side of the platform, and wherein the at least one contact pin is joined with the platform on at least a diaphragm-far side of the platform via the active hard solder, or braze, such that the titanium of the titanium core does not alloy with the melt of the active braze.
